(19) United States
(12) Patent Application Publication
(10) Pub. No.: US 2024/0390767 A1
(43) Pub. Date: Nov. 28, 2024

(54) TIMING BIOFEEDBACK SYSTEM THAT DETECTS START OF AN ACTION

(71) Applicant: BLAST MOTION INC., San Marcos, CA (US)

(72) Inventors: Michael FITZPATRICK, San Marcos, CA (US); Bhaskar BOSE, San Marcos, CA (US)

(73) Assignee: BLAST MOTION INC., San Marcos, CA (US)

(21) Appl. No.: 18/797,464

(22) Filed: Aug. 7, 2024

Related U.S. Application Data
(63) Continuation-in-part of application No. 17/894,099, filed on Aug. 23, 2022.

(51) Int. Cl. A63B 71/06; A63B 24/00; A63B 60/46; A63B 69/00; A63B 69/36; A63B 69/38; A63B 102/18

(52) U.S. Cl. CPC A63B 71/0622; A63B 24/0006; A63B 60/46; A63B 69/0002; A63B 69/0015; A63B 69/3685; A63B 69/38; A63B 2024/0015; A63B 2069/0008; A63B 2071/0625; A63B 2102/18; A63B 2102/182; A63B 2220/44; A63B 2220/62; A63B 2220/833; A63B 2225/50

(57) ABSTRACT

A system that detects when a user starts an action, such as a golf stroke or tennis stroke, and provides feedback to indicate the desired timing of one or more phases of the action. For example, timing feedback signals may be sent to indicate when each phase should ideally finish as a training aid to guide the user towards improving performance of the action. Equipment used by the user may be equipped with an inertial motion sensor that captures data throughout the action; data may be transmitted to a processor, such as a mobile device or a server, for analysis, and feedback signals (such as audio tones) may be sent to the user throughout the action based on this analysis. The user may initiate an action at any time, without needing a prompt from the system to begin the action, since the system may dynamically detect when an action begins.

This application is a continuation-in-part of U.S. Utility patent application Ser. No. 17/894,099, filed 23 Aug. 2022, the specification of which is hereby incorporated herein by reference.

### BACKGROUND OF THE INVENTION

### Field of the Invention

One or more embodiments setting forth the ideas described throughout this disclosure pertain to the field of motion capture sensors and analysis of motion capture data. More particularly, but not by way of limitation, one or more aspects of the invention enable a timing biofeedback system that detects start of an action.

### Description of the Related Art

Effective putting requires precise, repeatable movement of the putter so that the putter face contacts the golf ball in exactly the right orientation and with the desired velocity. Manual training aids are available to assist a golfer in learning a correct putt stroke. For example, golfers can print or purchase a matt with a slightly curved track that the putter head should follow for an ideal stroke, and they can practice following this track. A drawback of these manual aids is that the golfer must transport them to any location where he or she wants to practice putting. In addition, the golfer is responsible for watching the putt stroke relative to the putting aid; feedback on the quality of the stroke is not automatic.

Current sensor technologies enable a potential alternative to these manual putting aids which has not yet been incorporated into the prior art. A system that senses the precise motion of a putter may be used for putt stroke training by comparing the actual motion to the desired motion and generating “biofeedback” signals to the golfer to indicate whether the putting stroke has the desired characteristics. There are no known systems that provide putting biofeedback based on motion sensor data.

More generally, biofeedback may be applied to the performance of any action, for example by analyzing data from motion sensors attached to equipment used by the user to perform the action. One type of biofeedback may be used to help the user perform one or more phases of an action with the correct timing. For example, a user may begin an action and then feedback signals may indicate when each phase of the action should ideally end. Existing systems that generate feedback for timing typically require the user to start an action when a specific cue is given from the system. There are no known systems that allow a user to start an action at any time, without a cue from the system, and that detect this start of action and generate timing signals thereafter.

For at least the limitations described above there is a need for a timing biofeedback system that detects start of an action.

### BRIEF SUMMARY OF THE INVENTION

Embodiments of the invention enable a timing biofeedback system that detects start of an action. A golfer may use the system for putt training and practice. The system may track the position and orientation of the putter, calculate metrics for putts, and generate feedback signals that help the golfer improve the putt strokes.

One or more embodiments of the invention may include an inertial sensor coupled to a putter, a feedback signal generator configured to transmit a feedback signal to the user, and a processor coupled to the inertial sensor via a network and coupled to the feedback signal generator. The sensor may have an accelerometer, a gyroscope, and a network interface. The network interface may be wireless in one or more embodiments. The accelerometer may be a three-axis accelerometer and the gyroscope may be a three-axis gyroscope in one or more embodiments. The inertial sensor may be configured to capture inertial sensor data during a putting session wherein a user performs one or more putt strokes with the putter, and to stream this data over the network interface as the data is captured. The processor may be configured to receive the inertial sensor data, determine a starting time of a putt stroke and calculate one or more putt stroke metrics from the data, calculate a feedback signal value from the putt stroke metrics, and transmit the feedback signal value to the feedback signal generator.

In one or more embodiments the processor may calculate the feedback signal value and transmit this value to the feedback signal generator at multiple times during the putt stroke prior to the ending time of the putt stroke.

In one or more embodiments the processor and the feedback signal generator may be integrated into a mobile device used by the user.

In one or more embodiments the feedback signal generator may include a speaker and the feedback signal may be an audio output from the speaker. The feedback signal value may include one or more of pitch and volume of the audio output.

In one or more embodiments, feedback may be based on backstroke timing. The stroke metrics may include the duration of a backstroke, which is the elapsed time between the starting time of the putt stroke and the current time. When the duration of the backstroke equals or exceed a target backstroke duration, the feedback signal value may be set to a stop backstroke value.

In one or more embodiments, feedback may be based on the putter orientation at address. The stroke metrics may include the actual orientation of the putter at address, and the feedback signal value may be set based on the difference between this orientation at address and an ideal putter orientation at address.

In one or more embodiments, feedback may be based on the putter trajectory. The stroke metrics may include the distance travelled by the putter face since the starting time of the putt stroke, and a change in orientation of the putter face since this starting time. When the change in orientation is within a target face orientation range that is a function of the distance travelled, the feedback signal may be set to an on track value; otherwise the feedback signal may be set to an off track value that differs from the on track value.

In one or more embodiments, the processor may be configured to be in a feedback mode selected from multiple feedback modes, and the calculation of the feedback signal value may be a function of the feedback mode. In one or more embodiments the multiple feedback modes may include a backstroke timing feedback mode (with the feedback signal based on backstroke timing as described above), an orientation at address feedback mode (with the feedback signal based on putter orientation at address as described above), and a putter trajectory feedback mode (with the feedback signal based on the putter trajectory as described above).

One or more embodiments of the invention may enable a timing biofeedback system that detects the start of an action. The system may include an inertial sensor with an accelerometer, a gyroscope, and a network interface. The inertial sensor may be configured to capture inertial sensor data during a session when the user performs the action with the piece of equipment, and to stream this inertial sensor data over the network interface as the data is captured. The action may include one or more phases. Each phase may have an associated ideal duration. The system may include a feedback signal generator that transmits one or more feedback signals to the user. The system may include a processor coupled to the inertial sensor and to the feedback signal generator. The processor may be configured to receive the inertial sensor data, and to detect a starting time of the action based on the inertial sensor data without generating a prompt to indicate to the user to start the action. When the starting time of the action is detected, for each phase of the action, the processor may start a timer with a duration equal to the ideal duration associated with the phase, and when the timer expires, transmit a feedback signal to the feedback signal generator, and continue to a subsequent phase of the action unless the current phase is the last phase.

In one or more embodiments, the action may include one or more of a putt, a golf stroke, a stroke of a racquet, or a swing of a bat.

In one or more embodiments, detecting the starting time of the action based on the inertial sensor may include one or more of: determining whether one or more of the piece of equipment and the user are in a correct orientation to start said action; determining whether one or more of the piece of equipment and the user are substantially stationary before the starting time of the action; determining whether one or more of the piece of equipment and the user move or rotate at a speed or acceleration above a threshold value; and, determining whether one or more of the piece of equipment and the user move in an expected direction or rotate on an expected axis.

### BRIEF DESCRIPTION OF THE DRAWINGS

The above and other aspects, features and advantages of the ideas conveyed through this disclosure will be more apparent from the following more particular description thereof, presented in conjunction with the following drawings wherein:

FIGS. 1A and 1B show elements of an illustrative putting biofeedback system that changes audio tones emitted by a mobile phone based on whether a putter is following the desired trajectory.

FIG. 1A shows feedback for a correct putter trajectory, and FIG. 1B shows feedback for a trajectory that deviates from the desired path.

FIG. 2 shows detailed components of the sensor installed on the putter of FIG. 1A, and it shows illustrative processing steps that analyze the stream of data transmitted by the sensor to the mobile device.

FIG. 3 illustrates calculation of putting metrics from sensor data streamed by the sensor throughout the putt.

FIG. 4 illustrates dynamic detection of the start of a putt backstroke from sensor data.

FIG. 5 shows three illustrative feedback modes that may be enabled by one or more embodiments, and the processing steps performed in each mode.

FIG. 6 shows an illustrative mode that provides feedback on how close the putter orientation at address is to a target orientation.

FIG. 7 shows an illustrative mode that provides feedback on whether a putter face is following an expected relationship between distance and putter face orientation through the backstroke.

FIG. 8 shows an illustrative architecture of computer or processor hardware that may be used for elements of the system, including the sensor and the mobile device or server that processes sensor data.

FIG. 9 shows an illustrative action in tennis with two distinct phases—a backstroke and a forward stroke, with optimal timing defined for each phase.

FIG. 10 shows an illustrative biofeedback system for the tennis stroke action of FIG. 9; the system detects the start of the stroke action and provides feedback to indicate when each phase of the stroke should be completed.

FIG. 11 shows a flowchart of illustrative steps to implement a general timing biofeedback system for any action with one or more phases.

FIG. 12 shows illustrative analysis steps that may be used in one or more embodiments of the invention to detect the start of an action.

### DETAILED DESCRIPTION OF THE INVENTION

A timing biofeedback system that detects start of an action will now be described. In the following exemplary description numerous specific details are set forth in order to provide a more thorough understanding of the ideas described throughout this specification. It will be apparent, however, to an artisan of ordinary skill that embodiments of ideas described herein may be practiced without incorporating all aspects of the specific details described herein. In other instances, specific aspects well known to those of ordinary skill in the art have not been described in detail so as not to obscure the disclosure. Readers should note that although examples of the innovative concepts are set forth throughout this disclosure, the claims, and the full scope of any equivalents, are what define the invention.

In one or more embodiments of the invention, the motion of a putter may be measured with one or more sensors, and sensor data may be analyzed to generate feedback signals that are transmitted to the golfer. This process may occur in almost real-time, so that as soon as the golfer makes an error or as soon as a correction is needed, a feedback signal may be sent. This rapid feedback loop may substantially enhance the learning cycle for putting.

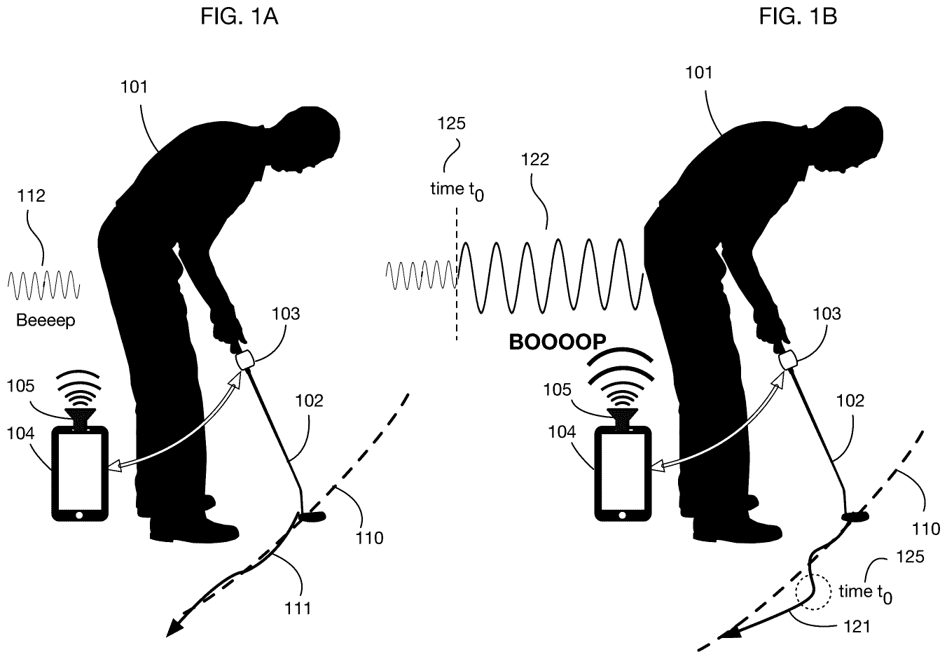

Sensors that measure the motion of the putter may for example be integrated into or attached to the putter. (In one or more embodiments, alternative or additional sensors may be used that are not fixed to the putter, such as video cameras that observe the putting stroke for example.) FIGS. 1A and 1B show an illustrative embodiment with putter 102 that has an inertial motion sensor package 103 integrated into or coupled to the putter. For example, the inertial sensor may be placed into the grip of the putter. Sensor 103 may capture data during movements of putter 102 by user 101. Data may be captured many times per second; for example, an illustrative embodiment may capture data 500 or more times per second. The sensor 103 may include or be coupled to a network interface, such as a wireless interface, so that sensor data can be streamed from the sensor immediately after it is captured. The wireless interface may be for example, without limitation, Bluetooth, Bluetooth Low-Energy, or Wi-Fi. Streamed sensor data may be received by one or more processors and may be analyzed to generate feedback signals on the characteristics of the user's putting strokes or other movements with the putter. In the embodiment show in FIGS. 1A and 1B, streamed sensor data is received by a mobile device 104, such as the user's mobile phone. Data may be received by or transmitted to any processor or processors for analysis. For example, in lieu of a mobile device, the sensor 103 may transmit data to a local gateway that forwards the data to a web-based server for analysis. Mobile device 104 may also communicate with other servers or devices, and data analysis may be performed by any combination of processors that are network connected. Mobile device 104 may be for example, without limitation, any type of phone, watch, laptop, desktop, tablet, server, or any other device or devices with network and processing capabilities.

The processor(s) that analyze sensor data, such as mobile device 104, may determine characteristics of the user's putt stroke from this data, with specific examples described below. For example, the processor(s) may calculate putt stroke metrics or other values that indicate whether the putt has desired features. Based on these calculations, one or more feedback signals may be transmitted to the user 101. Feedback may be generated using any type of actuators or signal generators. In the example shown in FIGS. 1A and 1B, the system generates audio feedback, using for example one or more speakers 105 integrated into or attached to mobile device 104. This type of feedback is illustrative; other types of feedback signals that may be used in one or more embodiments may include, without limitation, vibration, lights, visual displays, or temperature. Feedback signal generators may be located in any location where feedback signals can reach user 101. These feedback signal generators may be coupled to any processor that analyzes sensor data or receives the results of these analyses. Feedback may use any type of variation in the signals transmitted to the user. For example, audio feedback may consist of changes in pitch or volume, or in the presence or absence of certain sounds; visual feedback may consist of changes in intensity or presence of lights, or changes in the color of light, or changes in the frequency of flickering lights or strobes.

In the scenario illustrated in FIG. 1A, the system is configured to provide feedback to the user on how well the user is following desired trajectory 110 for the putter head. This trajectory may represent an ideal path for the putting stroke, which may in some cases depend on factors such as the user's height and stance, the characteristics of putter 102, or the desired path of the struck ball. The user 101 may be for example practicing repetitive strokes with the putter along this trajectory to generate muscle memory for this specific motion. In FIG. 1A, the user moves the putter along path 111 that follows trajectory 110 closely. The processor in mobile device 104 calculates this trajectory and generates a “positive” audio feedback signal 112, which may for example be a high-pitched tone at a low volume. This signal indicates to user 101 that the putt stroke is correct. In the scenario shown in FIG. 1B, the putter path 121 initially follows the desired trajectory 110, but at time 125 it deviates substantially from the desired trajectory. The audio feedback signal for this putt stroke therefore changes at time 125 to a different signal 122, which may for example be a lower-pitched and higher volume tone, signaling to the user that the path has deviated from the desired trajectory. Because data may be streamed continuously from sensor 103 to processor 104, and analyzed incrementally as it is received, the feedback signal can change almost immediately when the deviation occurs. A high sampling rate by sensor 103 may reduce the lag between a change in the putt motion and the resulting change in the feedback signal.

The specific audio signals described with respect to FIGS. 1A and 1B are illustrative; one or more embodiments of the invention may use any type of signal or signals set to any output levels. For example, the audio feedback for a correct putt stroke (within desired limits) may be silence, and any audible tone may indicate a deviation from the desired stroke. Feedback signals may be set to either discrete or continuous levels. For example, the tone or volume of audio feedback (or signal levels of any mode of feedback) may vary continuously as deviations from desired putt motions increase, or feedback signals may change discretely from a “positive” signal when the putt is within desired limits to a “negative” signal when the putt is outside desired limits.

The criteria for feedback described with respect to FIGS. 1A and 1B—following the desired putt trajectory—is also illustrative. One or more embodiments of the invention may evaluate any aspect of a putt and provide feedback according to how actual putter motion conforms to any desired criteria. Illustrative examples are described below.

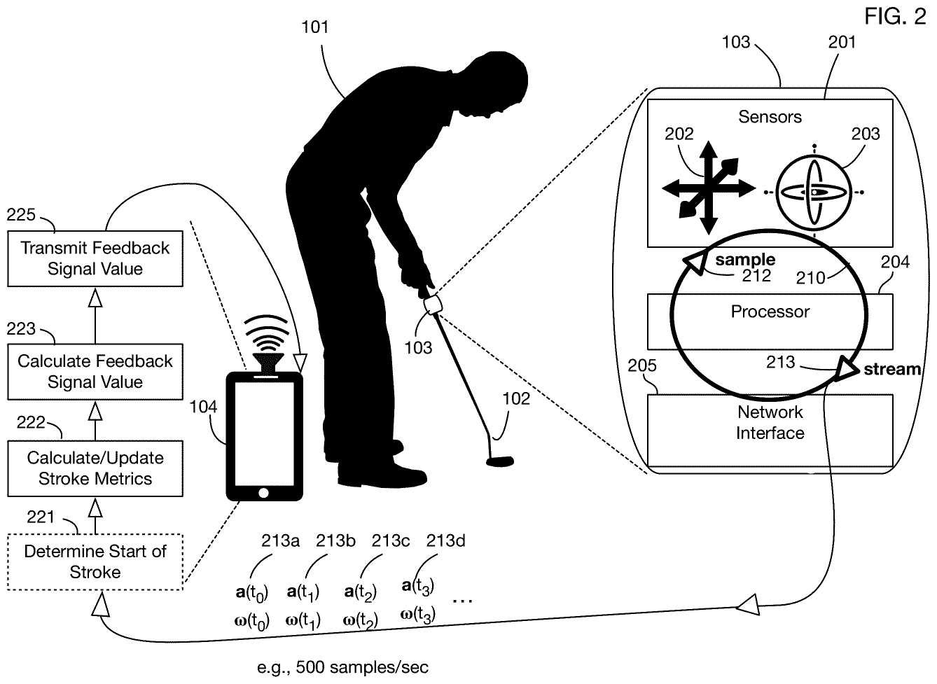

FIG. 2 shows illustrative components of sensor unit 103 that measures motion of putter 102. The sensors 201 contained in 103 may include for example, without limitation, inertial motion sensors such as a 3-axis accelerometer 202 and a 3-axis rate gyroscope 203. One or more embodiments of the invention may use other sensors or addition sensors, such as for example a magnetometer, a range sensor, or a position sensor. Any type or types of sensors that measure the position or orientation or changes in position or orientation of the putter may be used in one or more embodiments. Sensor unit 103 may also include a processor 204, which may be a microprocessor or microcontroller for example. It may also include one or more network interfaces 205, which may include wireless interfaces such as Bluetooth, Bluetooth Low Energy, or Wi-Fi. One or more embodiments of the invention may include memory in the sensor unit 103. The sensor unit may also have a power supply such as a battery or an energy harvesting device.

Processor 204 may execute a sampling and streaming loop 210 that repeatedly performs sampling 212 of sensors 201 and then streaming 213 of the sampled values to one or more other systems or processors for analysis. In one or more embodiments the processor 204 within the sensor unit may also perform analysis of sensor data and may stream resulting analyses to other systems. FIG. 2 shows sensor data samples 213a, 213b, 213c, and 213d streamed successively to mobile device 104 (or any other processor or gateway) at successive times. In one or more embodiments, data may be sampled and streamed at multiple points in time throughout a putt stroke or other motion, potentially at a high sampling rate such as 500 samples or more per second.

As device 104 receives streamed samples such as 213a, 213b, 213c, and 213d, it processes these samples to determine the state of the putter and to calculate feedback signals accordingly. Samples may be processed successively as they arrive, or in batches; processing of individual samples may be more computationally intensive but provides the benefit of faster feedback. FIG. 2 shows illustrative processing steps 221 through 225 that may be performed in one or more embodiments. These steps may be performed by any processor or processors, including any combination of sensor processor 204, mobile device 104 processor, or any servers connected to these devices via network connections. Some steps may be omitted or rearranged in one or more embodiments or in certain feedback modes. Step 221 analyzes sensor data to determine when a putting stroke begins. This step may be performed while a user is preparing to start a backstroke. In contrast to some putt training systems, detection of the start of a stroke is dynamic in that the user can start a stroke at any time and the system will detect when the stroke begins. (Some other systems require a user to begin a stroke upon a signal such as an audio cue.) Step 222 calculates or updates one or more stroke metrics from the raw sensor data. As described below, these metrics may reflect any aspect of a putt, such as the putter position or orientation or any changes therein, or any values derived from a putter trajectory. Step 223 then calculates one or more feedback signal values from the update metrics. These signal values may reflect for example any deviations between calculated metrics and desired metric values. Step 225 then transmits the feedback signal value(s) to the signal generator(s) that generate signals accessible to user 101.

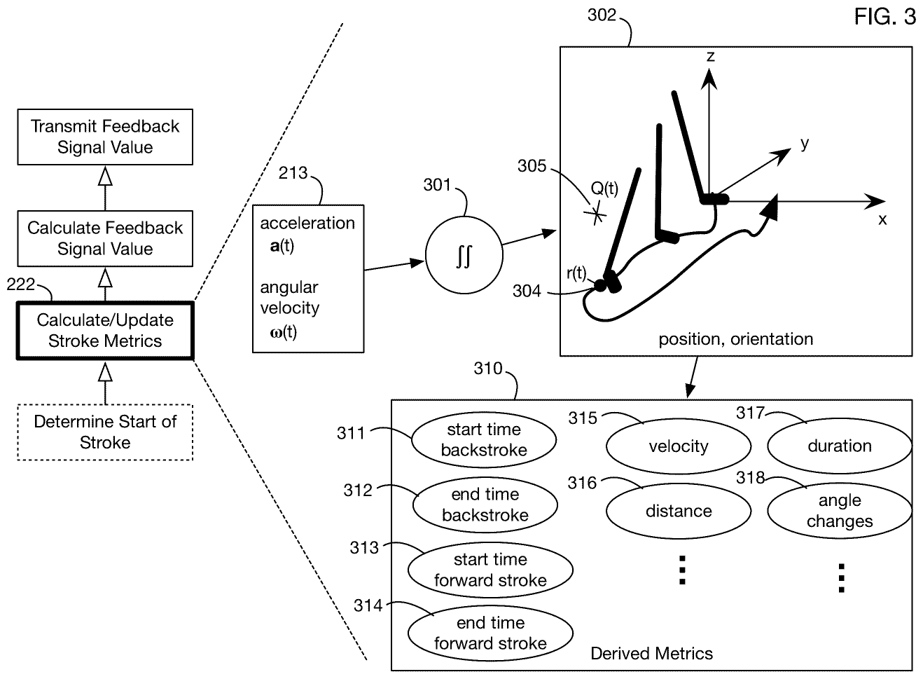

FIG. 3 shows an illustrative example of specific calculations in step 222. Incoming sensor samples 213, which may include for example acceleration and angular velocity vectors, may be integrated in step 301 to form a trajectory 302 of the position 304 and orientation 305 of the putter over time. Treating the putter as a rigid body, sensor values from any location on the putter may be integrated to determine the position of any point on the putter and the orientation of any portion of the putter. Techniques for integrating inertial sensor data to derive position and orientation over time are known in the art, and one or more embodiments of the invention may use any of these known techniques. For example, the integration 301 may calculate the position over time of the sweet spot of the putter face, and the orientation over time of this putter face.

From the position and orientation trajectory 302, many possible metrics 310 may be calculated. The specific metrics generated in any embodiment may depend on the particular type of feedback that is desired for the putting stroke. Illustrative metrics that may be calculated may include, without limitation, the start and ending times 311 and 312 of the backstroke; the start and ending times 313 and 314 of the forward stroke; the durations 317 of the backstroke, forward stroke, or any other phases of the stroke; the velocity 315 of any portion of the putter (such as the sweet spot) at any point in time, the distance 316 travelled by the putter face over any period of time, and the changes 318 in any of the angles of the putter face over any period of time. Additional metrics may for example be derived from or based on any combinations of these factors, or based on comparisons of any of these factors to any thresholds or standards.

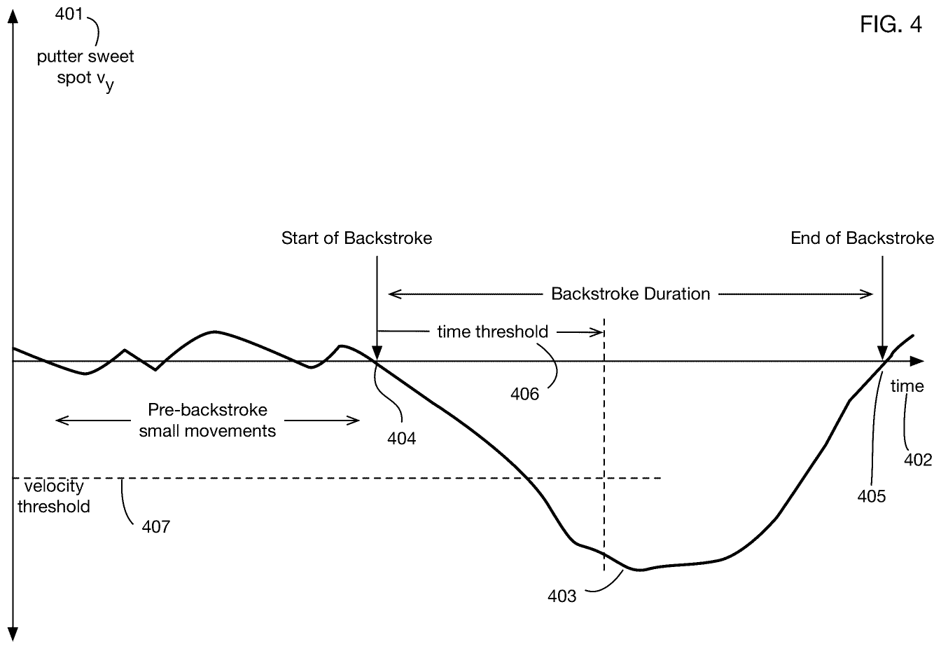

FIG. 4 shows an illustrative method that may be used in one or more embodiments to determine the starting time of a putt backstroke. As described with respect to FIG. 3, sensor data may be integrated to obtain the position of the sweet spot of the putter over time. The sweet spot velocity vector may then be obtained as the derivative of the position. Using a coordinate system as shown in 302 of FIG. 3, with the y-axis pointing in the desired direction of a putt, a backstroke corresponds to a negative y velocity of the sweet spot. FIG. 4 shows an illustrative plot 403 of the y-velocity 401 of the sweet spot as a function of time 402. As a golfer prepares to start a putt, the putter face typically moves slightly back and forth, so that y-velocity may become slightly negative prior to the true start of the backstroke. However, once a negative y-velocity has been sustained for a threshold period of time 406 or has exceeded (in the negative direction) a (negative) threshold velocity value 407, it can be determined that an actual backstroke has begun. The start of backstroke 404 can then be determined as the time of the last zero crossing of curve 403 before the y-velocity becomes sustainably negative. Similarly, the end of backstroke time 405 can be determined as the subsequent zero crossing when the y-velocity is no longer negative.

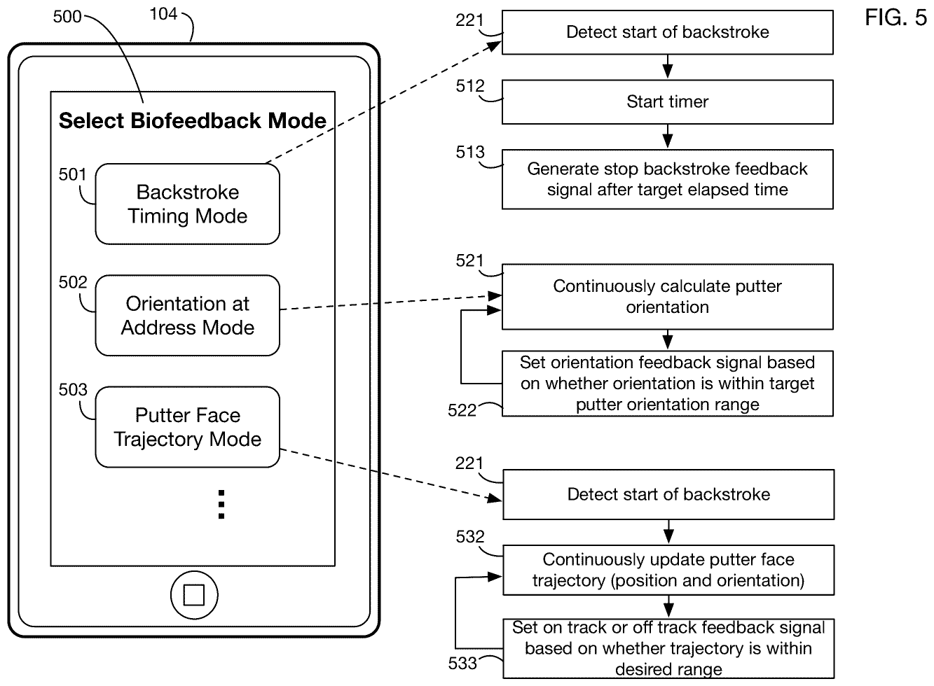

In one or more embodiments of the invention, a user may be able to select from several different feedback modes, where each feedback mode provides feedback on a particular aspect of putting. One or more embodiments may also provide multi-mode feedback where putt motions are monitored simultaneously for multiple aspects. FIG. 5 shows an illustrative embodiment that supports at least three modes of feedback, as selected in input screen 500 of mobile device 104. Mode 501 provides feedback on the timing of a backstroke. Mode 502 provides feedback on the putter orientation at address. Mode 503 provides feedback on the trajectory of the putter face through the backstroke. When the user selects an input control to set the mode, the processing of incoming sensor data is configured to provide feedback on the selected putting aspect.

In backstroke timing mode 501, the user may be guided to use a consistent backstroke that has a fixed target backstroke duration. This target duration may be based on accepted or common standards, or it may be configurable by the user. A putt stroke metric of the elapsed time between the start of the stroke and the current time may be compared to the target duration, and when this elapsed time equals or exceed the target duration, feedback may be generated to signal that the backstroke should stop. In one or more embodiments, the analysis system may first detect the start of a backstroke in step 221, using for example the method described with respect to FIG. 4, and then start a timer in step 512 with a duration equal to the target backstroke elapsed time. When the timer expires, a stop backstroke feedback signal may be generated in step 513 to tell the user that the backstroke motion should stop. In another embodiment of this feedback mode, the system may measure the backstroke duration (as shown in FIG. 4), and may provide a feedback signal based on comparing the actual backstroke duration with a target duration. In one or more embodiments feedback may also be provided on the timing of the forward stroke; for example a forward stroke timer may be started at the end of backstroke (either the actual detected end of backstroke or the expected time based on the target elapsed time). When the forward stroke timer expires after an expected forward stroke duration, another feedback signal may be provided to the golfer indicating that the forward stroke should be finished.

In orientation at address mode 502, the user may be guided to hold the putter in a correct orientation at address. In this mode, step 521 calculates the putter orientation for each new sensor data sample, and the analyzing processor then sets a feedback signal in step 522 based on whether the calculated orientation is within a target putter orientation range. This cycle repeats while the system remains in orientation at address mode.

In putter face trajectory mode 503, the user may be guided to make a backstroke with a simple pendulum-like rotation of the shoulders, without making other movements that may result in the putter face being skewed when it hits the ball after the forward stroke, which may result in a poor putt. A proper backstroke is reflected in a trajectory of the putter face with a specific curve for the putter face position and orientation as the putter head moves backwards through the backstroke. In this mode, after detection of the start of backstroke in step 221, the analysis system may update the putter face trajectory (both position and orientation) on each new sample, in step 532, and set a feedback signal based on comparison of this trajectory to the desired trajectory in step 533. For example, without limitation, feedback may be binary: an “on track” signal may be generated if the trajectory is close to the desired trajectory, and an “off track” signal may be generated if the trajectory deviates too much from the desired trajectory. Steps 532 and 533 may repeat in a loop for each new sensor data sample.

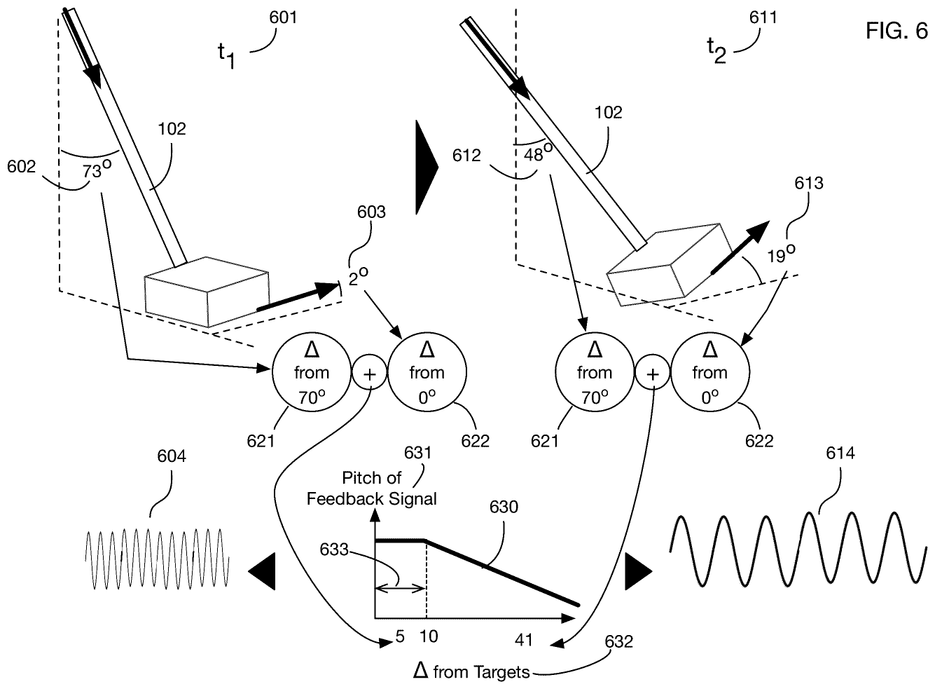

FIG. 6 shows an illustrative scenario for a system operating in “orientation at address” mode. The ideal orientation at address may in general depend on the putter geometry and potentially on other factors such as the terrain for the putt. In the scenario of FIG. 6, the ideal orientation for the putter 102 at address is a lie angle of 70 degrees (measured between the putter shaft and the vertical axis) and a loft angle of 0 degrees (measured between the normal to the putter face and the horizontal plane). The feedback signal is an audio signal with a pitch that varies depending on how close the actual putter orientation is to these ideal angles. The pitch 631 is calculated using curve 630 that is a function of the total absolute differences 632 of the lie and loft angles to their ideal values. At time 601, the lie angle 602 and loft angle 603 are relatively near the ideal values, so the sum of absolute differences 621 and 622 results in a high-pitched audio feedback signal 604. This high pitch indicates to the golfer that the orientation is at or near the ideal orientation. Subsequently at time 611, the lie angle 612 and the loft angle 613 differ significantly from their ideal values, so the sum of angle differences results in a low-pitched audio feedback signal 614. This pitch indicates to the golfer that the orientation needs to be corrected. If the golfer makes an adjustment in the correct direction, curve 630 shows that the pitch will increase, while adjustments in the wrong direction will decrease the pitch. The golfer is therefore guided by the feedback signal to put the putter in the correct orientation at address.

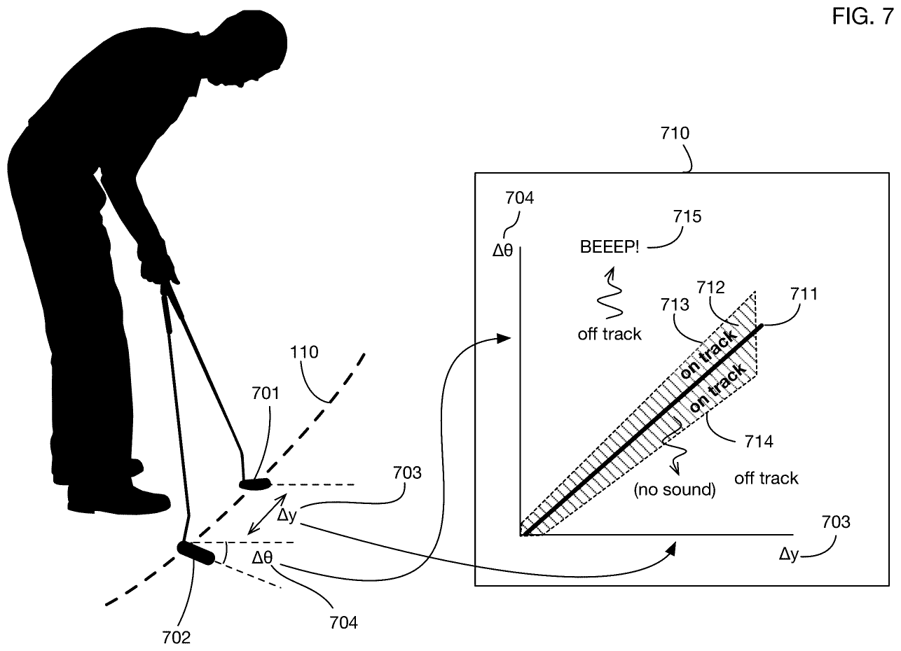

FIG. 7 shows an illustrative scenario for a system operating in “putter face trajectory” mode. For a backstroke that follows an ideal “pendulum motion” trajectory, the change 704 in the face angle of the putter from the point of address 701 to any point 702 on the backstroke is approximately a linear function of the distance 703 travelled by the putter head. This linear function is shown as line 711 in graph 710. In one or more embodiments, an “off track” feedback signal may be generated if the actual change in face angle deviates sufficiently from line 711; otherwise, an “on track” feedback signal may be generated. For audio feedback, on-track and off-track signals may have different frequencies for example; or in one or more embodiments, there may be no sound for on-track putts, and a sound for an off-track putt. In the embodiment shown in FIG. 7, the region between lines 713 and 714 defines the “on track” zone, and the feedback for on-track putts is no sound; outside this zone the feedback for off-track putts is a beep 715 that signals the need for a correction. In one or more embodiments a feedback signal may vary continuously based for example on the distance between the actual face angle and the desired face angle as described by line 711. One or more embodiments may base feedback signals on other changes in putter face orientation besides face angle, such as loft and lie angles, or combinations of angle changes, using similar relationships between putter face orientation and distance.

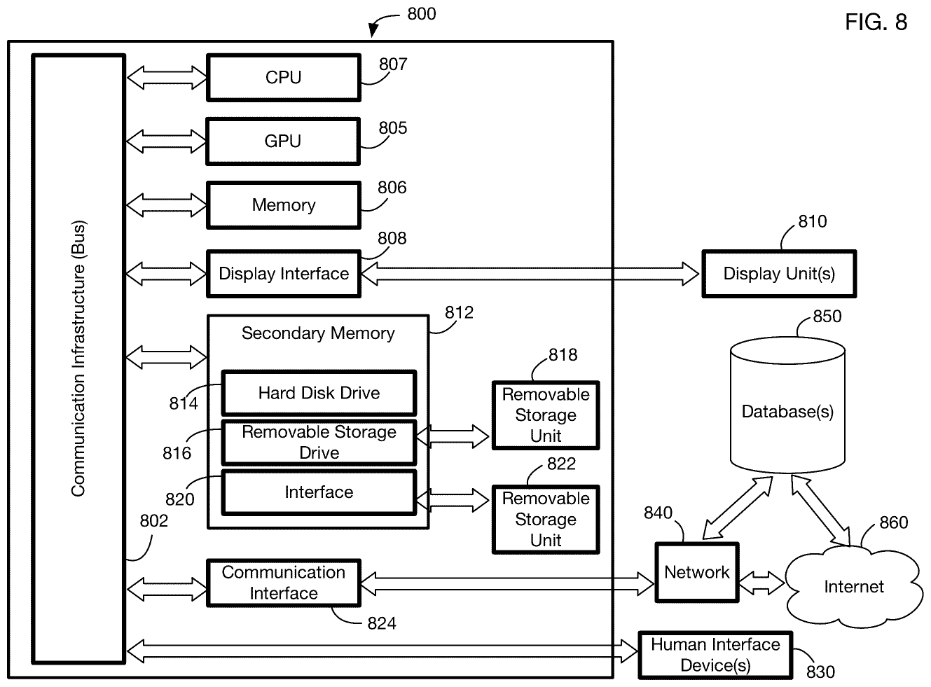

FIG. 8 shows an embodiment of exemplary computer 800 that may be utilized in, by, or as any component in the system. For example, any of the elements shown in computer 800 may be incorporated into a sensor unit, or into a mobile device other processor that analyzes sensor data. In one or more embodiments, computer 800 may be a network of computers, each of which may have any or all of the components shown in FIG. 8. In one or more embodiments, computer or computers 800 may also be utilized to implement any function in the system, i.e., any step or act or function that executes in any computer or server or engine in the system. Computer 800 may include processor CPU 807 that executes software instructions specifically tailored to the respective functions of embodiments of the invention. The software instructions, otherwise known as computer program instructions, may reside within memory 806. Computer 800 may include processor GPU 805, which may execute graphics instructions or other instructions for highly parallel operations, for example. GPU program instructions may also reside within memory 806. Computer 800 may include display interface 808, which may drive display unit or units 810 of any computer in the system as desired. Some computers 800 may or may not utilize a display. Computer 800 may include communication interface 824, which may include wireless or wired communications hardware protocol chips. In one or more embodiments of the invention communication interface 824 may include telephonic and/or data communications hardware. In one or more embodiments communication interface 824 may include a Wi-Fi™ and/or BLUETOOTH™ wireless communications interface. Any wireless network protocol or type may be utilized in embodiments of the invention. CPU 807, GPU 805, memory 806, display interface 808, communication interface 824, human interface devices 830, secondary memory 812, such as hard disk 814, removable storage 816, secondary memory interface 820 and removable storage units 818 and 822 may communicate with one another over communication infrastructure 802, which is commonly known as a “bus”. Communications interface 824 may communicate over any wired or wireless medium that allows for communication with other wired or wireless devices over network 840. Network 840 may communicate with Internet 860 and/or database or databases 850. Database 850 may be utilized to implement any database described herein.

One or more embodiments of the invention may provide biofeedback signals for any type of action, including but not limited to putting strokes. Biofeedback may be based for example on sensor data from one or more sensors attached to a user or to a piece of equipment. As described above for putting, this biofeedback may for example analyze inertial sensor data, or other sensor data, using a processor such as a smart phone or computer. Biofeedback may be used to signal to a user whether he or she is correctly performing an action, or to signal when one or more phases of the action should start or end. Actions may include for example, without limitation, movements in any sport of a piece of equipment or of any part of the user's body, movements in any activity such as dance or martial arts, or manipulations of industrial equipment, military equipment, or tools. Sports actions may include for example, without limitation, golf strokes with any club or putter, tennis strokes or serves or similar motions in any racquet sport, or swings of a bat such as a baseball, softball, or cricket bat.

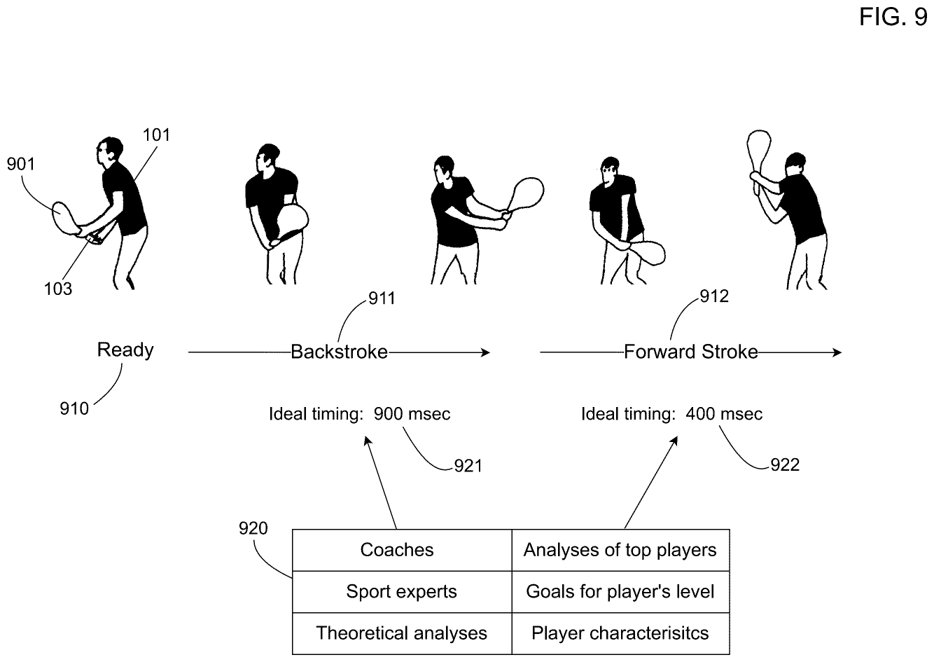

One illustrative type of biofeedback that may be provided in one or more embodiments is a “metronome”-like signal or signals to assist users in learning or checking that they are using the correct timing for their actions. Feedback signals may indicate to a user that an action or a certain portion of an action should start or complete. FIG. 9 shows an illustrative example of an action—a tennis stroke—that can be divided into two distinct phases: the backstroke, and the forward stroke. (The illustrative action in FIG. 9 is divided into two phases; other types of actions may be divided into any number of phases.) In the example shown in FIG. 9, a user 101 holds a tennis racquet 901, and a sensor 103 is attached to the racquet. As described above with respect to FIGS. 1A, 1B, and 2, sensor 103 may for example include inertial motion sensors. In an ideal tennis stroke, the user begins in a correct ready position 910, and then executes a backstroke 911 followed immediately by a forward stroke 912. In some situations, there may be optimal durations 921 and 922 for each of the two stroke phases 911 and 912, respectively. The optimal durations may be ranges in some situations, rather than specific values. Various factors 920 may be used to determine the optimal duration of a phase of an action, which may in some cases differ by users or by the context in which the activity takes place (such as practice vs. competition). These factors 920 may include for example, without limitation, input from coaches or sports experts, theoretical analysis of the biomechanics of an action, analyses of top players to characterize their durations for activity phases, goals for a player's current level or for a level the player aspires to, and characteristics of the player such as body type, training, age, or ranking.

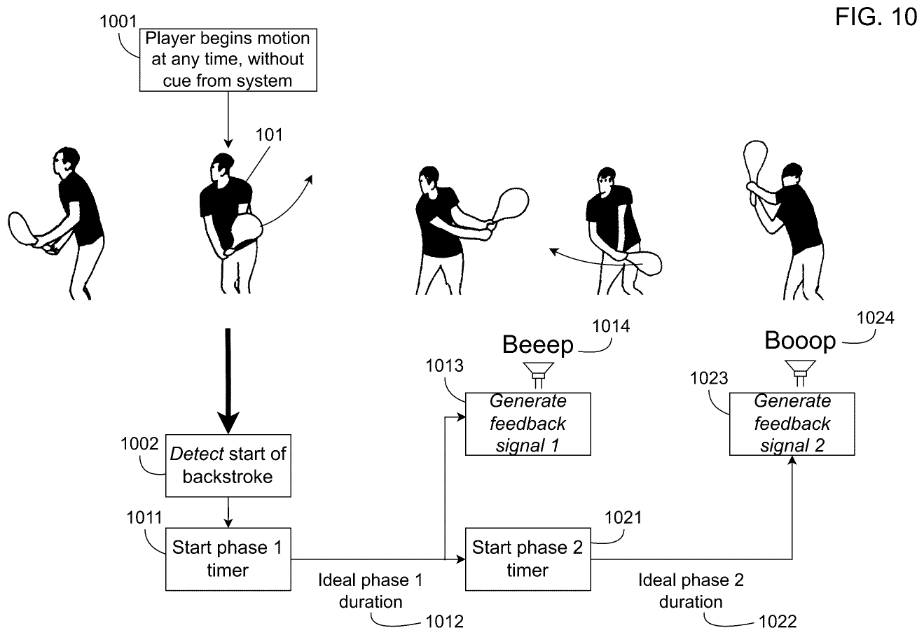

One or more embodiments of the invention may provide biofeedback that corresponds to the optimal timing of the phases of actions, such as the backstroke and forward stroke of FIG. 9. A system that provides timing biofeedback for the tennis stroke action of FIG. 9 is illustrated in FIG. 10. The steps shown in FIG. 10 may be executed for example by a processor such as mobile phone 104, or by any other device with a processor that receives sensor data. The first step 1001 is performed by user 101 when he or she begins an action (in this case the backstroke phase of the tennis stroke). In one or more embodiments of the invention, the user may begin an action at any time. The system may not generate any type of prompt (such as an audible signal) that indicates to the user that he or she can start the action. Because the user does not wait for a cue from the system to begin an action, the user can perform actions spontaneously, even for example during competition; this is a significant benefit of the invention. The system then performs step 1002 to detect the start of the action. In effect, the user is prompting the system by beginning an action, instead of the system prompting the user to begin an action. Step 1002 may for example perform any analyses of a stream of sensor data from a sensor attached to the user or to the equipment to determine that an action has started. For timing biofeedback, the system may then start a timer 1011 that begins when the action starts, and that ends when the first phase of the action should have completed (according to the ideal duration of the phase). When the timer expires after this ideal phase duration 1012, the system generates a feedback signal 1013 to the user, such as an audible signal 1014. When practicing for example, the user can use this signal 1014 to adjust the timing of the action phases to approach the ideal timing. On expiration of the phase 1 timer, since this action has two phases, the system also performs step 1021 to start another timer for phase 2. When this second timer expires after the ideal phase 2 duration 1022, the system performs step 1023 to generate a second feedback signal, such as another audio signal 1024. In some situations, the feedback signals may be different for different phases of an action; for example, audio tones may differ for audio signal 1014 for phase 1 and audio signal 1024 for phase 2.

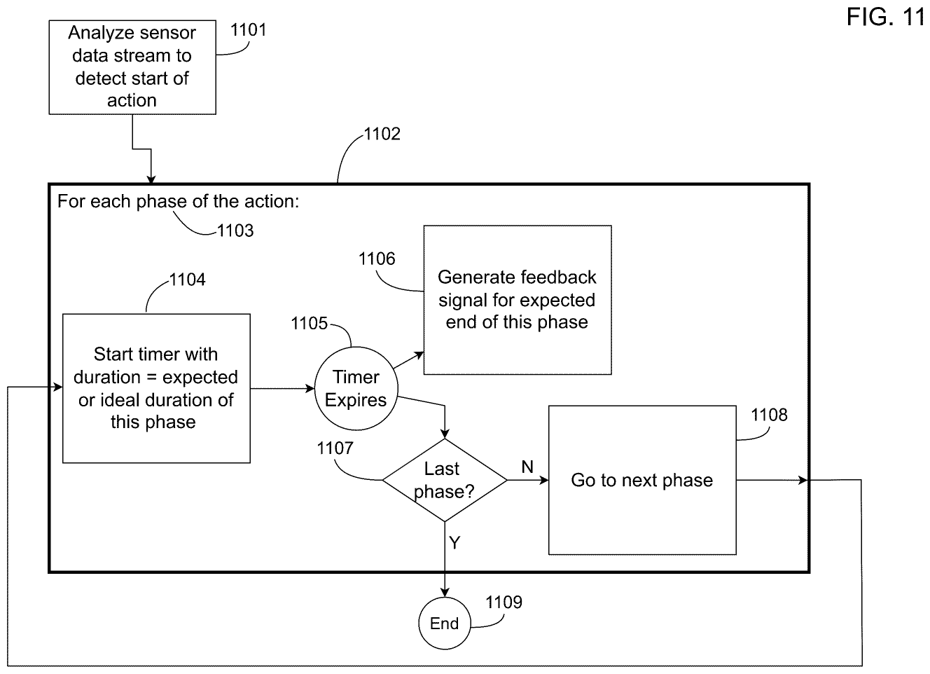

FIG. 11 shows a flowchart of steps that may be performed in one or more embodiments of the invention to provide timing feedback for any type of action with any number of phases. This flowchart is a generalization of the steps shown in FIG. 10 for a tennis stroke. All of these steps may be performed by a processor such as mobile phone 104. The initial step 1101 is to analyze a stream of sensor data from one or more sensors coupled to the user or the equipment (or both) to detect the start of an action. Once the start of action is detected, an iterative loop 1102 is performed for each phase 1103 of the action. At the start of each iteration, step 1104 starts a timer with timer duration equal to the expected or ideal duration of this phase. When the timer expiration event 1105 occurs, the system generates a feedback signal 1106 for the expected end of the phase. It also performs test 1107 of whether the current phase is the last phase. If so, it terminates 1109; otherwise, it advances in step 1108 to the next phase. Starting a timer for a subsequent phase may occur immediately after expiration of the previous phase's timer.

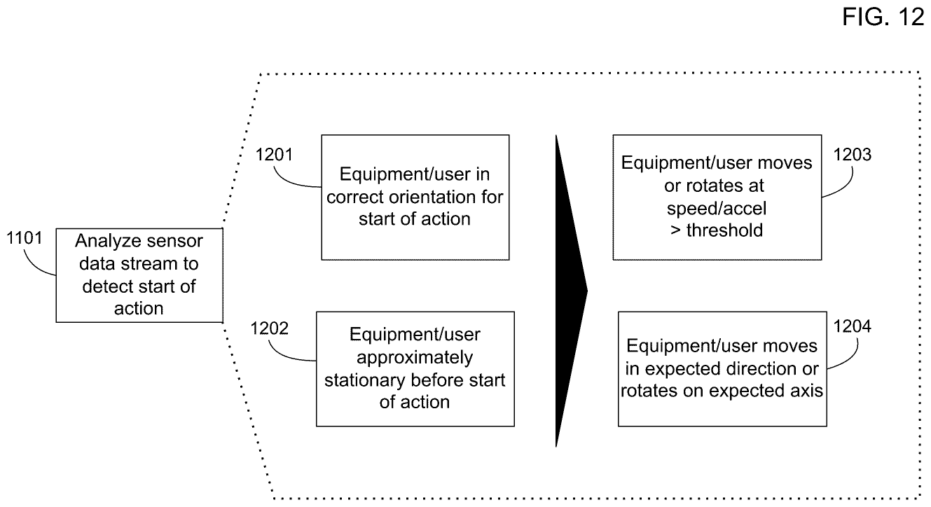

Step 1101 of detecting the start of an action may perform any type or types of analyses on sensor data. FIG. 12 shows some illustrative methods that may be used individually or in combination in one or more embodiments to detect the start of an action. These illustrative methods are grouped into methods 1201 and 1202 that may detect when the user or the equipment is in a “ready” position or orientation that is appropriate for the beginning of an action, and methods 1203 and 1204 that may detect when the user or equipment is moving in a manner consistent with expectations for the type of action. Method 1201 analyzes sensor data to determine whether the equipment and/or user are in a correct orientation to start the action. For example, for a putting stroke this analysis may test whether the putter face is level and the club is at the correct angle. Method 1202 analyzes sensor data to determine whether the equipment and/or user are stationary, or approximately stationary, before beginning an action. This may be important for certain actions like a golf stroke, while for other actions it may be expected that the user or equipment is moving before the action begins. Method 1203 analyzes the motion or rotation of the user or equipment to determine whether they are above a threshold that indicates that the action has definitely started. Method 1204 analyzes the direction of motion or the axis of rotation to determine whether this conforms with expectations for the action; for example, in a tennis stroke, the racquet starts the action by moving backwards. These methods 1201 through 1204 are illustrative; one or more embodiments of the invention may perform any analyses to determine whether and when an action starts.

While the ideas herein disclosed has been described by means of specific embodiments and applications thereof, numerous modifications and variations could be made thereto by those skilled in the art without departing from the scope of the invention set forth in the claims.

What is claimed is:

1. A timing biofeedback system that detects start of an action, comprising:
an inertial sensor coupled to a piece of equipment used by a user to perform an action, said inertial sensor comprising
an accelerometer;
a gyroscope; and
a network interface;
wherein
said inertial sensor is configured to
capture inertial sensor data during a session wherein said user performs said action with said piece of equipment; and,
stream said inertial sensor data over said network interface as said inertial sensor data is captured;
said action comprises one or more phases; and,
each phase of said one or more phases has an associated ideal duration;
a feedback signal generator configured to transmit one or more feedback signals to said user;
a processor coupled to said inertial sensor via a network connection, and coupled to said feedback signal generator, wherein said processor is configured to receive said inertial sensor data;
detect a starting time of said action based on said inertial sensor data without generating a prompt to indicate to said user to start said action;
when said starting time of said action is detected, for each phase of said one or more phases,
start a timer with a duration equal to said associated ideal duration associated with said each phase; and,
when said timer expires,
transmit a feedback signal to said feedback signal generator; and,
continue to a subsequent phase of said one or more phases unless said each phase is a last phase.

2. The timing biofeedback system that detects start of an action of claim 1, wherein said processor and said feedback signal generator are integrated into a mobile device used by said user.

3. The timing biofeedback system that detects start of an action of claim 1, wherein said accelerometer comprises a three axis accelerometer;
said gyroscope comprises a three axis gyroscope; and,
said network interface comprises a wireless network interface.

4. The timing biofeedback system that detects start of an action of claim 1, wherein said processor is further configured to calculate a feedback signal value, and wherein
said feedback signal generator comprises a speaker;
said feedback signal comprises an audio output from said speaker;
said feedback signal value comprises one or more of pitch and volume of the audio output.

5. The timing biofeedback system that detects start of an action of claim 1, wherein said feedback signal is different for each phase of said one or more phases.

6. The timing biofeedback system that detects start of an action of claim 1, wherein said action comprises one or more of
a putt;
a golf stroke;
a stroke of a racquet;
a swing of a bat.

7. The timing biofeedback system that detects start of an action of claim 1, wherein said detect a starting time of said action based on said inertial sensor data comprises one or more of
determine whether one or more of said piece of equipment and said user are in a correct orientation to start said action;
determine whether one or more of said piece of equipment and said user are substantially stationary before said starting time of said action;
determine whether one or more of said piece of equipment and said user move or rotate at a speed or acceleration above a threshold value; and,
determine whether one or more of said piece of equipment and said user move in an expected direction or rotate on an expected axis.

8. A timing biofeedback system that detects start of an action, comprising:
an inertial sensor coupled to a piece of equipment used by a user to perform an action, said inertial sensor comprising
an accelerometer;
a gyroscope; and
a network interface;
wherein
said accelerometer comprises a three axis accelerometer;
said gyroscope comprises a three axis gyroscope; and,
said network interface comprises a wireless network interface;
wherein
said inertial sensor is configured to:
capture inertial sensor data during a session wherein a user performs said action with said piece of equipment; and,
stream said inertial sensor data over said network interface as said inertial sensor data is captured;
said action comprises one or more phases; and,
each phase of said one or more phases has an associated ideal duration;
a feedback signal generator configured to transmit one or more feedback signals to said user;
a processor coupled to said inertial sensor via a network connection, and coupled to said feedback signal generator, wherein said processor is configured to
receive said inertial sensor data;
detect a starting time of said action based on said inertial sensor data without generating a prompt to indicate to said user to start said action;
when said starting time of said action is detected, for each phase of said one or more phases,
start a timer with a duration equal to said associated ideal duration associated with said each phase; and,
when said timer expires,
transmit a feedback signal to said feedback signal generator; and,
continue to a subsequent phase of said one or more phases unless said each phase is a last phase;
wherein said detect a starting time of said action based on said inertial sensor data comprises one or more of
determine whether one or more of said piece of equipment and said user are in a correct orientation to start said action;
determine whether one or more of said piece of equipment and said user are substantially stationary before said starting time of said action;
determine whether one or more of said piece of equipment and said user move or rotate at a speed or acceleration above a threshold value; and,
determine whether one or more of said piece of equipment and said user move in an expected direction or rotate on an expected axis.

9. The timing biofeedback system that detects start of an action of claim 8, wherein said processor is further configured to calculate a feedback signal value, and wherein
said feedback signal generator comprises a speaker;
said feedback signal comprises an audio output from said speaker;
said feedback signal value comprises one or more of pitch and volume of the audio output.

10. A timing biofeedback system that detects start of an action, comprising:
an inertial sensor coupled to a piece of equipment used by a user to perform an action, said inertial
sensor comprising
an accelerometer;
a gyroscope; and
a network interface;
wherein
said accelerometer comprises a three axis accelerometer;
said gyroscope comprises a three axis gyroscope; and,
said network interface comprises a wireless network interface;
wherein
said inertial sensor is configured to
capture inertial sensor data during a session wherein a user performs said action with said piece of equipment; and,
stream said inertial sensor data over said network interface as said inertial sensor data is captured;
said action comprises one or more phases; and,
each phase of said one or more phases has an associated ideal duration;
a feedback signal generator configured to transmit one or more feedback signals to said user;
a processor coupled to said inertial sensor via a network connection, and coupled to said feedback signal generator, wherein said processor is configured to
receive said inertial sensor data;
detect a starting time of said action based on said inertial sensor data without generating a prompt to indicate to said user to start said action;
when said starting time of said action is detected, for each phase of said one or more phases,
start a timer with a duration equal to said associated ideal duration associated with said each phase; and,
when said timer expires,
transmit a feedback signal to said feedback signal generator; and,
continue to a subsequent phase of said one or more phases unless said each phase is a last phase;
wherein said processor and said feedback signal generator are integrated into a mobile device used by said user;
wherein said feedback signal generator comprises a speaker;
wherein said feedback signal comprises an audio output from said speaker;
wherein said feedback signal is different for each phase of said one or more phases;
wherein said action comprises one or more of
a putt;
a golf stroke;
a stroke of a racquet;
a swing of a bat;
wherein said detect a starting time of said action based on said inertial sensor data comprises one or more of
determine whether one or more of said piece of equipment and said user are in a correct orientation to start said action;
determine whether one or more of said piece of equipment and said user are substantially stationary before said starting time of said action;
determine whether one or more of said piece of equipment and said user move or rotate at a speed or acceleration above a threshold value; and,
determine whether one or more of said piece of equipment and said user move in an expected direction or rotate on an expected axis.

11. The timing biofeedback system that detects start of an action of claim 10, wherein said processor is further configured to calculate a feedback signal value, and wherein
said feedback signal generator comprises a speaker;
said feedback signal comprises an audio output from said speaker;
said feedback signal value comprises one or more of pitch and volume of the audio output.
